(19) United States
(12) Patent Application Publication
(10) Pub. No.: US 2018/0051735 A1
(43) Pub. Date: Feb. 22, 2018

(54) TWIST LOCK SWIVEL / TWIST LOCK COUPLING

(71) Applicant: HYPERLOOP TRANSPORTATION TECHNOLOGIES, INC., CULVER CITY, CA (US)

(72) Inventor: ALEXANDER LEONIDOVICH STENYAKIN, LAKEVILLE, MN (US)

(21) Appl. No.: 15/683,301

(22) Filed: Aug. 22, 2017

Related U.S. Application Data
(60) Provisional application No. 62/378,034, filed on Aug. 22, 2016.

(51) Int. Cl. F16B 21/02; F16B 21/09

(52) U.S. Cl. CPC F16B 21/02; F16B 21/09

(57) ABSTRACT

A twist lock comprises two components—a male component and a female component, where the two components interlock with each other. A plurality of alignment features is provided within the female component for facilitating the male component to engage with the female component. The twist lock helps latch two separate pieces together where precise tight/closed position is required. The twist lock may also be employed in evacuated tube transportation (ETT) systems for automated docking.

### RELATED APPLICATIONS

This application claims the benefit of provisional application 62/378,034 filed Aug. 22, 2016.

### BACKGROUND OF THE INVENTION

### Field of Invention

The present invention relates generally to the field of couplings. More specifically, the present invention is related to a twist lock swivel/twist lock coupling.

### Discussion of Prior Art

The prior art provides for various coupling devices that couple a male component and a female component. Whatever the precise merits, features, and advantages of such prior art coupling devices, none of them achieves or fulfills the purposes of the present invention.

### SUMMARY OF THE INVENTION

In one embodiment, the present invention provides a twist lock comprising: (a) a male component comprising a vertical pin/ transverse rod 14 and a horizontal pin/transverse rod 5, the vertical pin/transverse rod 14 having a vertical alignment round 4; (b) a female component comprising a vertical sides alignment guide 7, a vertical center alignment guide 8, a twist guide 9, and a locking notch 13, wherein the horizontal pin/transverse rod 5 aligns with an opening in the female component and contacts vertical sides alignment guide 7 and vertical center alignment guide 8, where the vertical sides alignment guide 7 and the vertical center alignment guide 8 help align two pieces of the horizontal pin/transverse rod 5 on a vertical axis, and when vertical alignment round 4 reaches vertical sides alignment guide 7 and vertical center alignment guide 8, the male and female components of the twist lock align vertically and male component is twisted clockwise or pushed in, with the horizontal pin/transverse rod 5 contacting the twist guide 9 which guides it to a closing position when the horizontal pin/transverse rod 5 reaches locking notch 13.

In another embodiment, the present invention provides a twist lock comprising: a male component disposed at a docking station of an evacuated tube transportation (ETT) system, the male component comprising a vertical pin/transverse rod 14 and a horizontal pin/transverse rod 5, the vertical pin/transverse rod 14 having a vertical alignment round 4; a female component disposed on a capsule docking at the docking station, the female component comprising a vertical sides alignment guide 7, a vertical center alignment guide 8, a twist guide 9, and a locking notch 13, wherein the horizontal pin/transverse rod 5 aligns with an opening in the female component and contacts vertical sides alignment guide 7 and vertical center alignment guide 8, where the vertical sides alignment guide 7 and the vertical center alignment guide 8 help align two pieces of the horizontal pin/transverse rod 5 on a vertical axis, and when vertical alignment round 4 reaches vertical sides alignment guide 7 and vertical center alignment guide 8, the male and female components of the twist lock align vertically, and male component is twisted clockwise or pushed in, with the horizontal pin/transverse rod 5 contacting the twist guide 9 which guides it to a closing position when the horizontal pin/transverse rod 5 reaches locking notch 13, and wherein the male and female components assist in docking the capsule at the docking station.

### BRIEF DESCRIPTION OF THE DRAWINGS

FIGS. 1A-E illustrate the present invention's twist lock comprising a male component and a female component that interlock with each other.

FIG. 2 illustrates a capsule or pod as used in an evacuated tube transportation (ETT) system, where the present invention's twist lock is used to lock the capsule at a docking station.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

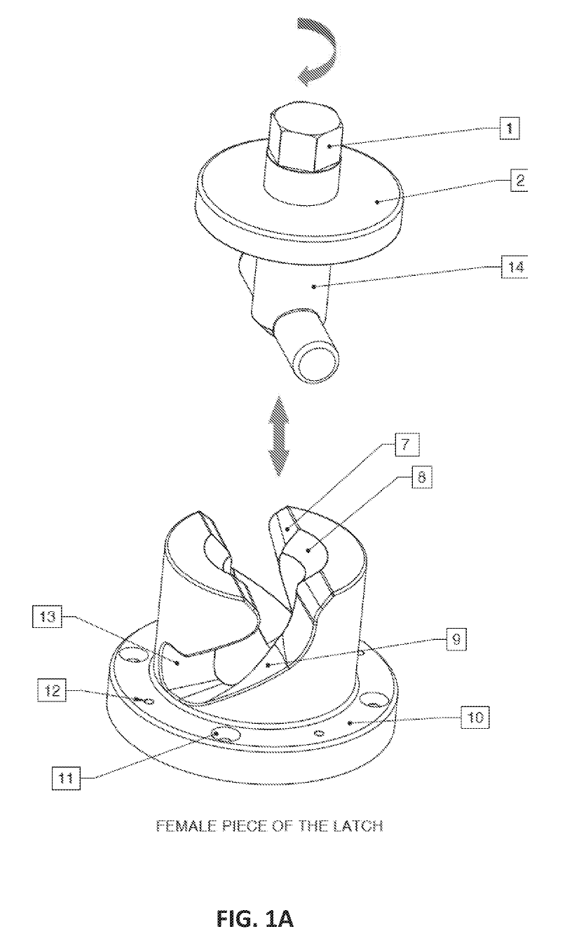

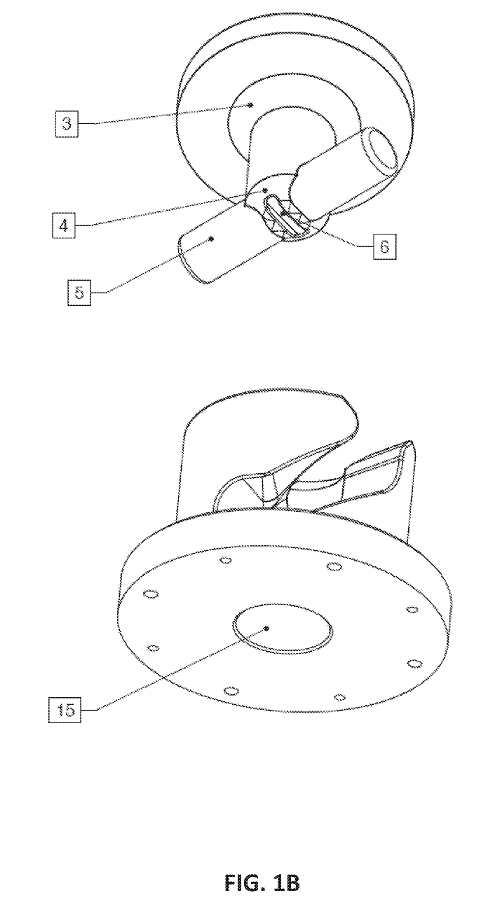

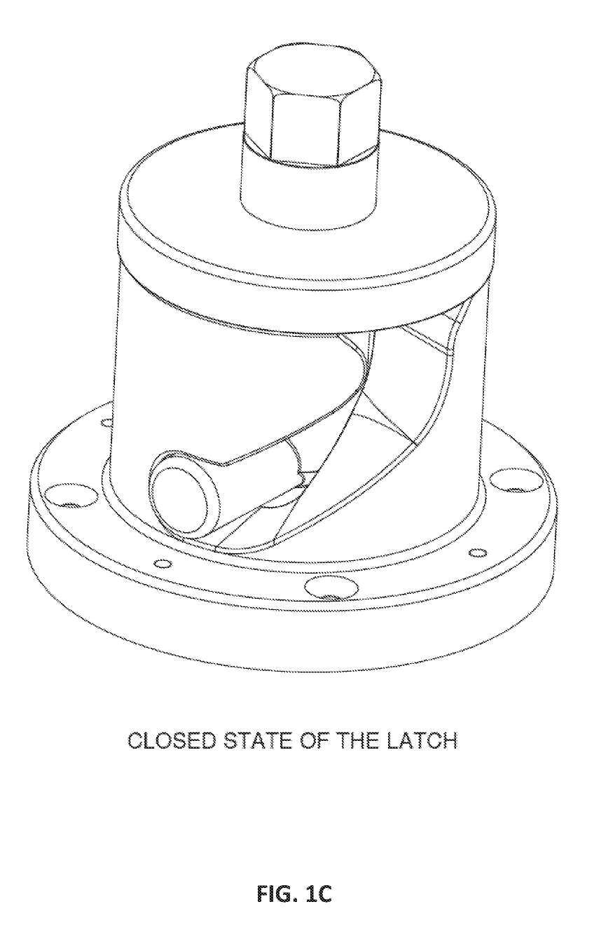

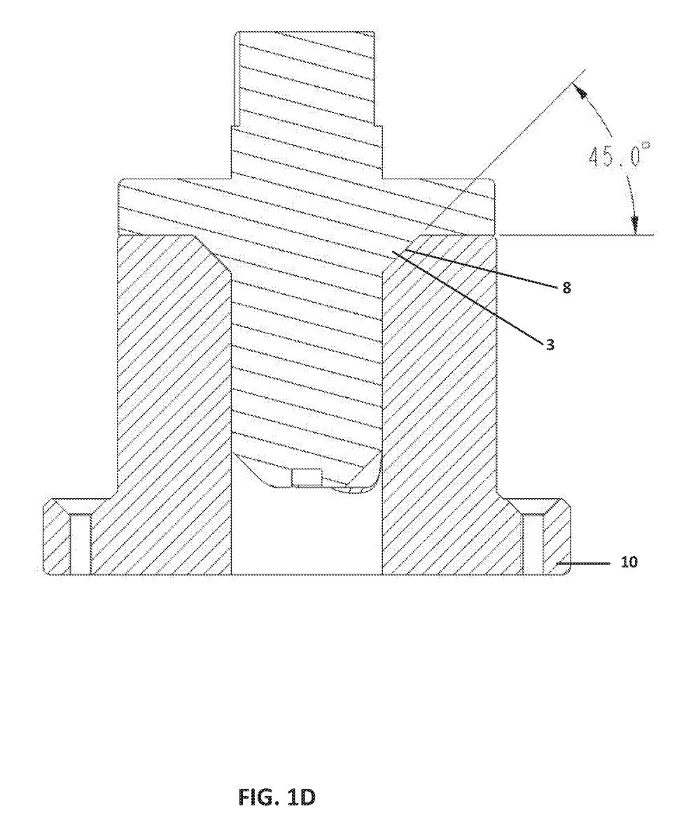

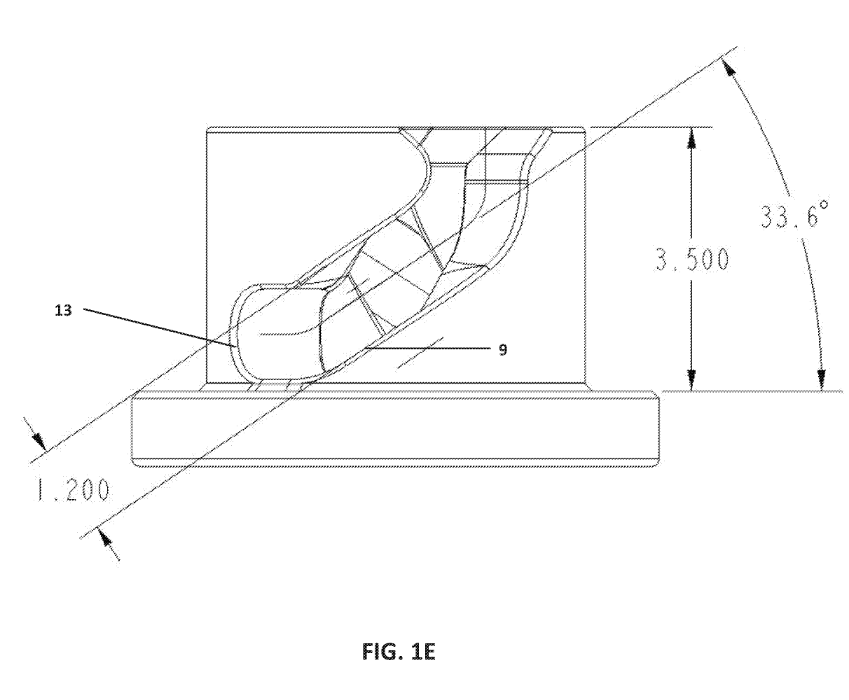

The present invention provides a twist lock as shown in FIGS. 1A-C comprising two components—a male component and a female component that interlock with each other. Within the female component, a plurality of alignment features is provided for facilitating the male component to engage with the female component. The present invention helps latch two separate pieces together where precise tight/closed position is required.

The following listing provides the various parts that make up the male and female components.
1—electric or pneumatic step motor connection
2—horizontal disk
3—horizontal alignment chamfer/guide
4—vertical alignment round
5—horizontal pin/transverse rod
6—manual emergency unlocking cut off
7—vertical sides alignment guide
8—vertical center alignment guide
9—twist guide
10—leveling base
11—screws holes
12—set screw thread holes
13—locking notch
14—vertical pin/transverse rod
15—maintenance cut off

Male component's horizontal pin/transverse rod 5 aligns with female opening and contacts vertical sides alignment guide 7 and vertical center alignment guide 8, where the vertical sides alignment guide 7 and vertical center alignment guide 8 help align two pieces of the horizontal pin/transverse rod 5 on the vertical axis.

It should be noted that there is a total of four vertical sides alignment guides 7, two on each side.

Once vertical alignment round 4 reaches vertical sides alignment guide 7 and vertical center alignment guide 8, the two pieces of the twist lock align vertically and male component can be twisted clockwise or pushed in.

Then, male component's horizontal pin/transverse rod 5 hits twist guide 9 which guides it to a closing position. When horizontal pin/transverse rod 5 reaches locking notch 13, the latch is closed. With final closing, horizontal alignment chamfer/guide 3 helps align male part horizontally.

When horizontal pin/transverse rod 5 gets close to locking notch 13, horizontal alignment chamfer/guide 3 engages with vertical center alignment guide 8 and centers the male and female components, on the vertical axis as shown in the vertical cross-section shown in FIG. 1D, which also depicts the slope of vertical center alignment guide 8, in the preferred embodiment, to be 45 degrees.

FIG. 1E depicts a cross-section of the female component of the present invention showing the slope of twist guide 9, in the preferred embodiment, to be 33.6 degrees. In one example, vertical sides alignment guide 7 has two features: its slope is 45 degrees and its round is 0.500 (thousandth of the inch). However, these angles and dimensions can be modified depending on the application.

The vertical sides alignment guide 7 is intended to help catch the male part component (particularly, horizontal pin/transverse rod 5 of the male component) in the beginning of the latching operation between the male and female components, particularly, if the male and female components are a bit misaligned during the engaging operation. Horizontal alignment chamfer/guide 3 and vertical center alignment guide 8 help alignment when male and female are almost in the closed position.

In one embodiment, male part horizontal pin/transverse rod 5 can be powered by electrical or pneumatic step motors for twisting or pushing motion. Motors can be connected to electric or pneumatic step motor connection 1 (which can be any shape needed for motor attachments) or it can be closed manually.

In one embodiment, when the motor or female/male part is damaged, a manual emergency unlocking cut off 6 can be used to open twist lock through maintenance cut off 15.

Female part can be bolted using screw holes 11 to any surface. Female part can be also leveled with set screws using set screw thread holes 12.

It should be noted that while the slope of the twist guide is shown in a particular slope, the twist guide 9's slope may be reversed in another design so it goes counter clock wise, without departing from the scope of the invention.

In one embodiment, the present invention is used for connecting flexible or non-flexible tubes, where the vertical pin/transverse rod 14 is drilled through to facilitate fluid passage. Also, in this embodiment, the female component would not have a cut off on the side, but would instead have a wall. Also, in this embodiment, O-ring may be used between the male and female components for a fluid-tight seal.

In another embodiment, protrusion sensors are added to the end of horizontal pin/transverse rod 5, where when the horizontal pin/transverse rod 5 reaches locking notch 13, the protrusion sensor senses presence of locking notch 13.

In yet another embodiment, female component can be made without leveling base 10 and simply welded to any metal surface.

In yet another embodiment, electric or pneumatic step motor connection 1 can be modified to any shape to work with any wrench or attachable handle.

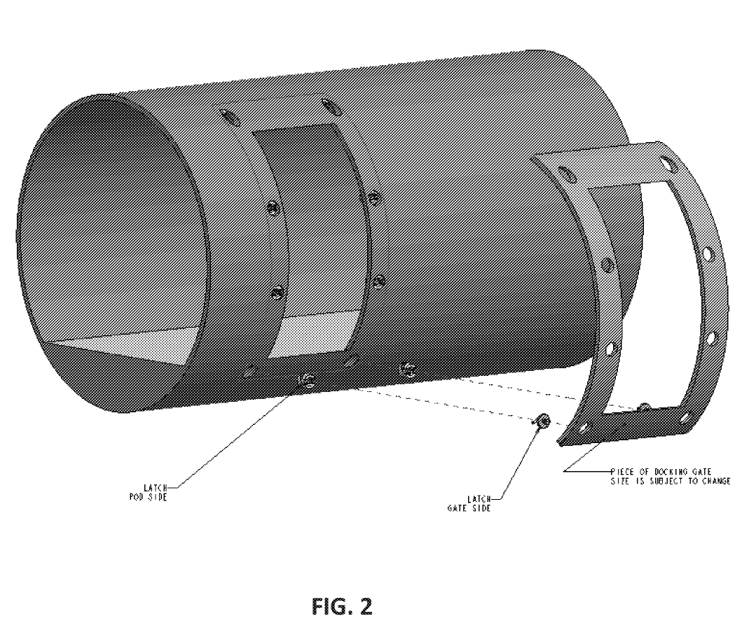

In one embodiment, the present invention's twist lock is used as a docking lock (called DockLock) in evacuated tube transportation (ETT) technologies during docking and sealing procedures. FIG. 2 illustrates a capsule or pod as used in an evacuated tube transportation (ETT) system, where the present invention's twist lock is used to lock the capsule at a docking station. In this embodiment, the female component is placed on the capsule or pod traversing the ETT structure and the male component is placed on the DockLock (docking station side), where the male and female components assist in docking the capsule or pod at the docking station.

The present invention's twist lock is useful in ETT systems such as Hyperloop-based ETT systems because: 1) there are two systems (i.e., the capsule and pod on one side and the docking station on the other side) where docking needs to be precise, and where the docking operation must have high repeatability, and 2) there is a seal O-ring that needs to be squeezed with certain force, where seal can't move. The present invention's twist lock solves misalignment issues with the pod and the docking station (on the X, Y, and Z vertices), squeezes seal with certain force (one latch can squeeze seal about 600 lb per linear foot), and locks pod to the station firmly and releases when needed. The present invention's twist lock, therefore, provides a very good solution for automated docking.

### CONCLUSION

A system and method has been shown in the above embodiments for the effective implementation of a twist lock swivel/twist lock coupling. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size, materials, or specific manufacturing techniques.

1. A twist lock comprising:
a male component comprising a vertical pin/transverse rod 14 and a horizontal pin/transverse rod 5, the vertical pin/transverse rod 14 having a vertical alignment round 4;
a female component comprising a vertical sides alignment guide 7, a vertical center alignment guide 8, a twist guide 9, and a locking notch 13,
wherein the horizontal pin/transverse rod 5 aligns with an opening in the female component and contacts vertical sides alignment guide 7 and vertical center alignment guide 8, where the vertical sides alignment guide 7 and the vertical center alignment guide 8 help align two pieces of the horizontal pin/transverse rod 5 on a vertical axis, and when vertical alignment round 4 reaches vertical sides alignment guide 7 and vertical center alignment guide 8, the male and female components of the twist lock aligns vertically and male component are twisted clockwise or pushed in, with the horizontal pin/transverse rod 5 contacting the twist guide 9 which guides it to a closing position when the horizontal pin/transverse rod 5 reaches locking notch 13.

2. The twist lock of claim 1, wherein when the female component or male component is damaged, a manual emergency unlocking cut off 6 disposed on vertical alignment round 4 allows opening of the twist lock through a maintenance cut off 15 in the female component.

3. The twist lock of claim 1, wherein the female component is secured to an external surface using screw holes 11.

4. The twist lock of claim 1, wherein the female component is secured to an external surface by welding.

5. The twist lock of claim 1, wherein the twist lock connects flexible tubes.

6. The twist lock of claim 1, wherein the twist lock connects non-flexible tubes.

7. The twist lock of claim 1, wherein one or more protrusion sensors are provided at the end of horizontal pin/transverse rod 5, where when the horizontal pin/transverse rod 5 reaches locking notch 13, the protrusion sensor senses presence of locking notch 13.

8. The twist lock of claim 1, wherein the male component further comprises an electric or pneumatic step motor connection 1 for twisting the male component.

9. The twist lock of claim 1, wherein a slope of the twist guide is 33.6°.

10. The twist lock of claim 1, wherein a slope of the center alignment guide is 45°.

11. The twist lock of claim 1, wherein the female component is part of a capsule in an evacuated tube transportation (ETT) system and the male component is part of a docking station, where the male and female components together assist in aligning and docking the capsule.

12. A twist lock comprising:
a male component disposed at a docking station of an evacuated tube transportation (ETT) system, the male component comprising a vertical pin/transverse rod 14 and a horizontal pin/transverse rod 5, the vertical pin/transverse rod 14 having a vertical alignment round 4;
a female component disposed on a capsule docking at the docking station, the female component comprising a vertical sides alignment guide 7, a vertical center alignment guide 8, a twist guide 9, and a locking notch 13,
wherein the horizontal pin/transverse rod 5 aligns with an opening in the female component and contacts vertical sides alignment guide 7 and vertical center alignment guide 8, where the vertical sides alignment guide 7 and the vertical center alignment guide 8 help align two pieces of the horizontal pin/transverse rod 5 on a vertical axis, and when vertical alignment round 4 reaches vertical sides alignment guide 7 and vertical center alignment guide 8, the male and female components of the twist lock align vertically and male component is twisted clockwise or pushed in, with the horizontal pin/transverse rod 5 contacting the twist guide 9 which guides it to a closing position when the horizontal pin/transverse rod 5 reaches locking notch 13, and
wherein the male and female components assist in docking the capsule at the docking station.

13. The twist lock of claim 12, wherein when the female component or male component is damaged, a manual emergency unlocking cut off 6 disposed on vertical alignment round 4 allows opening of the twist lock through a maintenance cut off 15 in the female component.

14. The twist lock of claim 12, wherein the female component is secured to an external surface using screw holes 11.

15. The twist lock of claim 12, wherein the female component is secured to an external surface by welding.

16. The twist lock of claim 12, wherein the twist lock connects flexible tubes.

17. The twist lock of claim 12, wherein the twist lock connects non-flexible tubes.

18. The twist lock of claim 12, wherein one or more protrusion sensors are provided at the end of horizontal pin/transverse rod 5, where when the horizontal pin/transverse rod 5 reaches locking notch 13, the protrusion sensor senses presence of locking notch 13.

19. The twist lock of claim 12, wherein the male component further comprises an electric or pneumatic step motor connection 1 for twisting the male component.

20. The twist lock of claim 12, wherein a slope of the twist guide is 33.6° and a slope of the center alignment guide is 45°.
